(19) United States
(12) Patent Application Publication
(10) Pub. No.: US 2017/0178185 A1
(43) Pub. Date: Jun. 22, 2017

(54) AD-HOC SUPPLY CHAIN CREATION

(71) Applicant: International Business Machines Corporation, Armonk, NY (US)

(72) Inventors: Albee Jhoney, Bangalore (IN); Hariharan Krishna, Hyderabad (IN); Kalpesh Sharma, Bangalore (IN)

(21) Appl. No.: 14/976,080

(22) Filed: Dec. 21, 2015

(51) Int. Cl. G06Q 30/02; G06F 17/28; G06Q 50/00

(52) U.S. Cl. CPC G06Q 30/0255; G06Q 30/0277; G06Q 50/01; G06F 17/28

(57) ABSTRACT

An online post on an online media platform is detected. The online post corresponds to a potential business enterprise. The online post includes a first element and a second element. The online post may be detected by the software plugin. The first and second elements are determined using natural language processing techniques. Vendor indications are received. The vendor indications indicate an ability and inclination for vendors to provide commercial offerings that match the first and/or second element. A prompt from a user is received. The prompt is to create ad-hoc supply chains for the business enterprise for the user. The first user has user characteristics. Ad-hoc supply chains are created that match vendors to the first and second elements for the user. The ad-hoc supply chains are provided to the user within a graphical user interface of the online media platform using the software plugin.

### BACKGROUND

Data which is available on the internet is increasing at a steady rate. Data can be found on a pseudo-infinite number of websites across the internet. The data of these websites may be stored on a likewise pseudo-infinite number of databases. Often data of a database is maintained at a local host, even while the data may be referenced by remote sources. Maintaining a database may include modifying data or creating new data, or creating new correlations between data. Even where the data is primarily referenced/utilized at a plurality of remote locations, data may be primarily modified locally for various reasons, whether technical (e.g., to improve data integrity), practical (e.g., a business policy to keep data in-house), or arbitrary.

Internet data is often presented on websites. These websites may function primarily as sources of information such as news sites, sources of social interaction such as social media sites, or sources of business deals such as an e-commerce site, among many other types of websites. These websites may include a number of public posts that may be viewed by visitors to the website. These posts may include text, audio, or video. These posts may relate to any topic and may be used by visitors to the website in numerous ways.

The post may relate to topics which may be monetized by consumers/users of the websites. For example, a website may have a post with an article relating to a new way to shine shoes. A consumer of the website may see the post and decide to pursue commercial activities related to the post. These commercial activities may require the engagement of a plurality of outside commercial vendors, who each use separate commercial systems to manage commercial activities. The consumer may use a plurality of programs and engage in a plurality of operations to allow each vendor to use remote commercial systems to assess the potential business enterprise.

Visitors to websites often want to alter the functionality or presentation of such websites. Visitors often act to alter the functionality or presentation using a software plugin. The plugin may alter how a web browser functions or how a specific web application functions, among other possible functions of a plugin.

### SUMMARY

Embodiments of the disclosure provide a method, system, and computer program product for the ad-hoc creation of supply chains using an online media software plugin. Embodiments of this method, system and computer program product enable integrations of systems over a network to allow a user to direct creation of an ad-hoc supply chain while also enabling vendors to influence and/or modify elements of the supply chain. An online post on an online media platform is detected. The online post corresponds to a potential business enterprise. The online post includes a first element and a second element. The online post may be detected by the software plugin. The first and second elements are determined using natural language processing techniques. Vendor indications are received. The vendor indications indicate an ability and inclination for vendors to provide commercial offerings that match the first and/or second element. A prompt from a user is received. The prompt is to create ad-hoc supply chains for the business enterprise for the user. The first user has user characteristics. Ad-hoc supply chains are created that match vendors to the first and second elements for the user. The ad-hoc supply chains are provided to the user within a graphical user interface of the online media platform using the software plugin. Providing data on ad-hoc supply chains within the graphical user interface by utilizing remote databases allows for the centralized analysis and presentation of decentralized data.

Embodiments of the disclosure provide a method for the ad-hoc creation of supply chains using an online media software plugin. Embodiments of this method enable autonomous creation of a supply chain by the plugin in real-time in response to media becoming available. The plugin detects an online post. The online post includes media of an online media platform. The media both corresponds to a business enterprise and includes a set of elements. The plugin determines the set of elements of the online post using natural language processing techniques. The plugin identifies a set of vendors that correlates with the set of elements using confidence scores. The set of vendors provide commercial offerings that correspond to the set of elements. The plugin provides the set of vendors and the set of elements to a user of the online media platform. The set of vendors and the set of vendors is provided within a graphical user interface (GUI) of the online media platform using the plugin. The plugin autonomously analyzing online media and determining ad-hoc supply chains for users allows for pseudo-immediate ad-hoc supply chain creation upon the posting of online media.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is an apparatus for ad-hoc supply chain creation, according to embodiments.

FIG. 2 is a computing environment for ad-hoc supply chain creation, according to embodiments.

FIG. 3 is a method of ad-hoc supply chain creation, according to embodiments.

FIG. 4A is a depiction of a graphical user interface (GUI) for ad-hoc supply chain creation, according to embodiments.

FIG. 4B is a depiction of a GUI for ad-hoc supply chain creation with vendor details, according to embodiments.

FIG. 5 is a depiction of a GUI of an ad-hoc supply chain, according to embodiments

While embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to various embodiments of a system and method for the ad-hoc creation of a supply chain in response to an online post from online media. The online post is detected by a software plugin. The plugin detects that the online post includes data related to an activity or commodity. The supply chain application breaks the data down into a set of individual elements which can recreate the activity or commodity. The plugin detects a set of vendors indicating an ability to supply one or more individual elements. The plugin analyzes the individual elements against databases of the vendors which are external to the online media. The vendor databases are remotely controlled by the vendors. The plugin grants a user the ability to compile an ad-hoc supply chain of possible vendors within a graphical user interface (GUI). Each element of the GUI may be remotely verified and controlled even while it is locally presented and (potentially) selected. While the present disclosure is not necessarily limited to such applications, various aspects of the disclosure may be appreciated through a discussion of various examples using this context. Examples and example values discussed herein are provided by way of example only and are not to be construed as limiting.

In instances, a user of online media sees a post in a first GUI displaying media of the internet. The user may identify the post as relating to a potential business enterprise. As such, the user may attempt to determine elements of the potential business enterprise and enter said elements into another GUI of a conventional supply chain management program. Such a conventional supply chain management program may allow a user to enter any elements which the user was able to identify. A user may then use the conventional supply chain management program to identify and enter vendors who potentially supply equivalent elements. Vendors may have been identified by a user with separate GUIs which relate to separate databases and applications. A user may manually communicate with these vendors to attempt to verify the ability/inclination/cost of said vendors to provide any elements. A user may often identify vendors who cannot or will not provide the element to the user, for any number of reasons. In response to identifying such unwilling and/or unable vendors, a user may then work to identify a replacement. A user may then use a conventional supply chain management program to display a supply chain created by the user. In this way a user may use a conventional supply chain management program to manually and independently create a supply chain in numerous stages using a plurality of programs.

Aspects of the disclosure are directed towards ad-hoc creation of supply chains. The supply chain is created by an application which functions as a plugin for online media. The plugin detects that a new post is made on social media. The new post relates to a new business enterprise, such as a new product or service. The plugin detects the individual elements of the new business enterprise which can be separately acquired, such as parts or shipping of the new product. Each of these individual elements may be disparate goods or services that, in conjunction, add up to the realization of the new business enterprise. Vendors provide an indication of an ability to provide one or more individual elements. Vendors may also connect the plugin to external databases controlled by the vendor to have up-to-date information. The plugin matches specific vendors to specific elements. The plugin detects a user query relating to the post. The user query may include a set of user data. In response to the query, the user data, and the vendor input, the plugin displays one or more ad-hoc supply chains to the user. The plugin may use a set of factors to create confidence scores relating to the various matches between vendors, elements, and the user. The user indicates a selection of one or more matches or supply chains. In response to user selections, the plugin sends information to and receives information from respective vendors. The plugin may allow numerous parties to independently indicate interest, and therein create ad-hoc supply chains for numerous users in numerous instances based on the vendor and user input for the particular post.

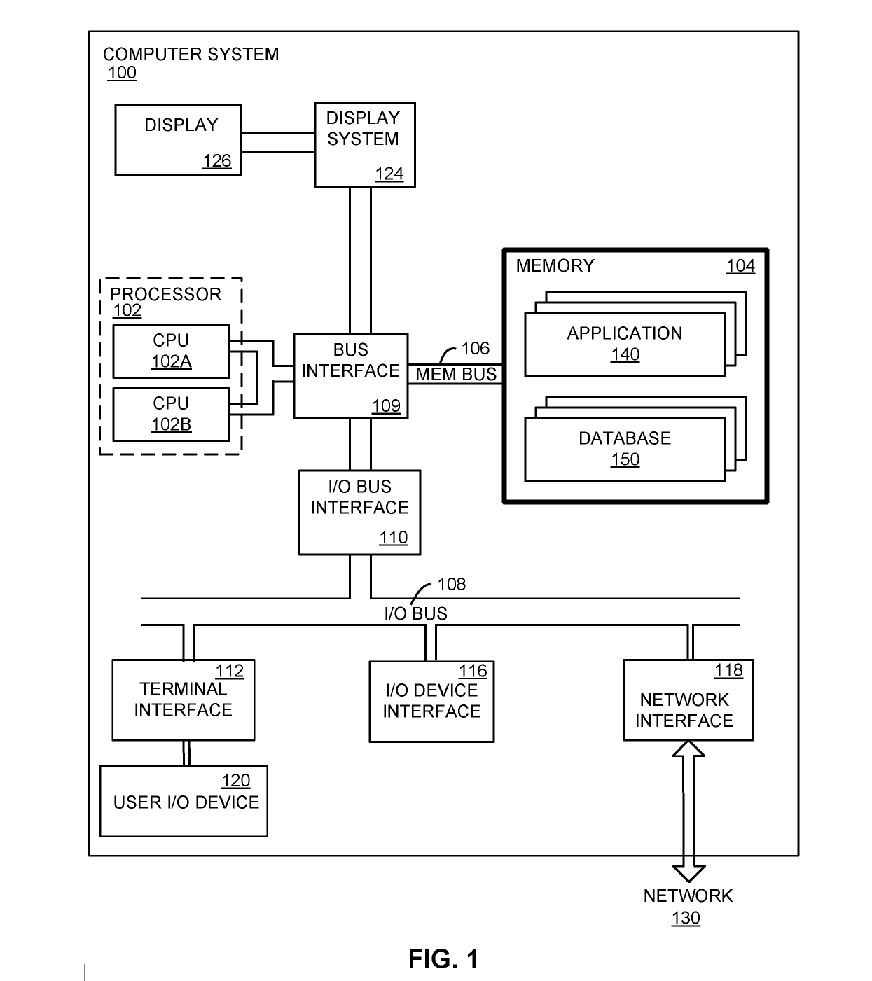

FIG. 1 depicts a high-level block diagram of a computer system 100 for ad-hoc supply chain creation. The elements of the various embodiments disclosed herein apply equally to any appropriate computing system. The elements of the example computer system 100 shown in FIG. 1 include a memory 104, a terminal interface 112, an I/O (Input/Output) device interface 116, and a network interface 118, all of which are communicatively coupled, directly or indirectly, for inter-element communication via a memory bus 106, an I/O bus 108, bus interface unit 109, and an I/O bus interface unit 110.

The computer system 100 include one or more general-purpose programmable central processing units (CPUs) 102A and 102B, herein generically referred to as the processor or processors 102. In some embodiments, the computer system 100 contains multiple processors; however, in certain embodiments, the computer system 100 alternatively includes a single CPU system. Each processor 102 executes instructions—such as the instructions from an application 140 to perform some acts described with respect to method 300—stored in the memory 104.

In some embodiments, the memory 104 includes a random-access semiconductor memory, storage device, or storage medium (either volatile or non-volatile) for storing or encoding data and programs. The memory 104 can include stored data in one or more databases 150. For example, databases 150 may include a catalog which includes products and services which the vendor offers, an inventory of how much product or service-people the vendor does/can have available, data on users, or historical data on vendors. In certain embodiments, the memory 104 represents the entire virtual memory of the computer system 100, and may also include the virtual memory of other computer systems coupled to the computer system 100 or connected via a network. In some embodiments, the one or more databases 150 and/or the one or more applications 140 may be stored in other computer systems of the network 130, and a supply chain plugin may access/communicate with the databases 150 and/or applications 140 through the network interface 118. For example, in some embodiments an application 140 which is the plugin on one instance of the computer system 100 may communicate with a separate instance of the computer system 100 which includes an application 140 which is a vendor billing system and a database 150 with vendor data. Additionally, in some embodiments, vendor and element confirmation may be submitted and/or gathered over the network 130.

The memory 104 stores all or a portion of the various programs, modules and data structures for creation of supply chains as discussed herein. For instance, the memory 104 can include the plugin as an application 140. In this illustrative embodiment, the plugin includes instructions or statements that execute on the processor 102 or instructions or statements that are interpreted by instructions or statements that execute on the processor 102 to carry out functions (e.g., the acts of method 300) as further described below. In certain embodiments, the application 140 is implemented in hardware via semiconductor devices, chips, logical gates, circuits, circuit cards, and/or other physical hardware devices (e.g., ASIC or FPGA) in lieu of, or in addition to, a processor-based system.

In this example, the computer system 100 includes a bus interface unit 109 to handle communications among the processor 102, the memory 104, a display system 124, and the I/O bus interface unit 110. The depicted I/O bus interface unit 110 is coupled with the I/O bus 108 for transferring data to and from the various I/O units. The I/O bus interface unit 110 communicates with multiple I/O interface units 112, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The depicted display system 124 is coupled with a display device 126, such as a standalone display screen, computer monitor, television, or a tablet or handheld device display. The display may be used to provide vendor/element information from the plugin to a user of the computer system 100. In one embodiment, the display device 126 may include one or more speakers for rendering audio. The audio may be audio of the online post (e.g., a podcast which describes one or more products). Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using an input device in order to provide input data and commands to programs such as the plugin. For example, a computer system 100 which includes an I/O device 120 may allow a user to provide user data or modify/select a supply chain provided by the plugin using such input devices 120 as a mouse and a graphical display. A user may also use input devices 120 to create an offer for vendors using the plugin, which may then be transmitted to the vendors using the network 130.

The I/O device interface 116 provides an interface to any of various other I/O devices or devices of other types, such as printers or fax machines. The network interface 118 provides one or more communication paths from the computer system 100 to other digital devices and computer systems.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

FIG. 1 depicts several example elements of the computer system 100. Individual elements, however, may have greater complexity than represented in FIG. 1, elements other than or in addition to those shown in FIG. 1 may be present, and the number, type, and configuration of such elements may vary. Several particular examples of additional complexity or additional variations are disclosed herein; these are by way of example only and are not necessarily the only such variations. The various program elements illustrated in FIG. 1 may be implemented, in various embodiments, in a number of different manners, including using various computer applications, routines, elements, programs, objects, modules, data structures, etc., which may be referred to herein as “software,” “computer programs,” or simply “programs.”

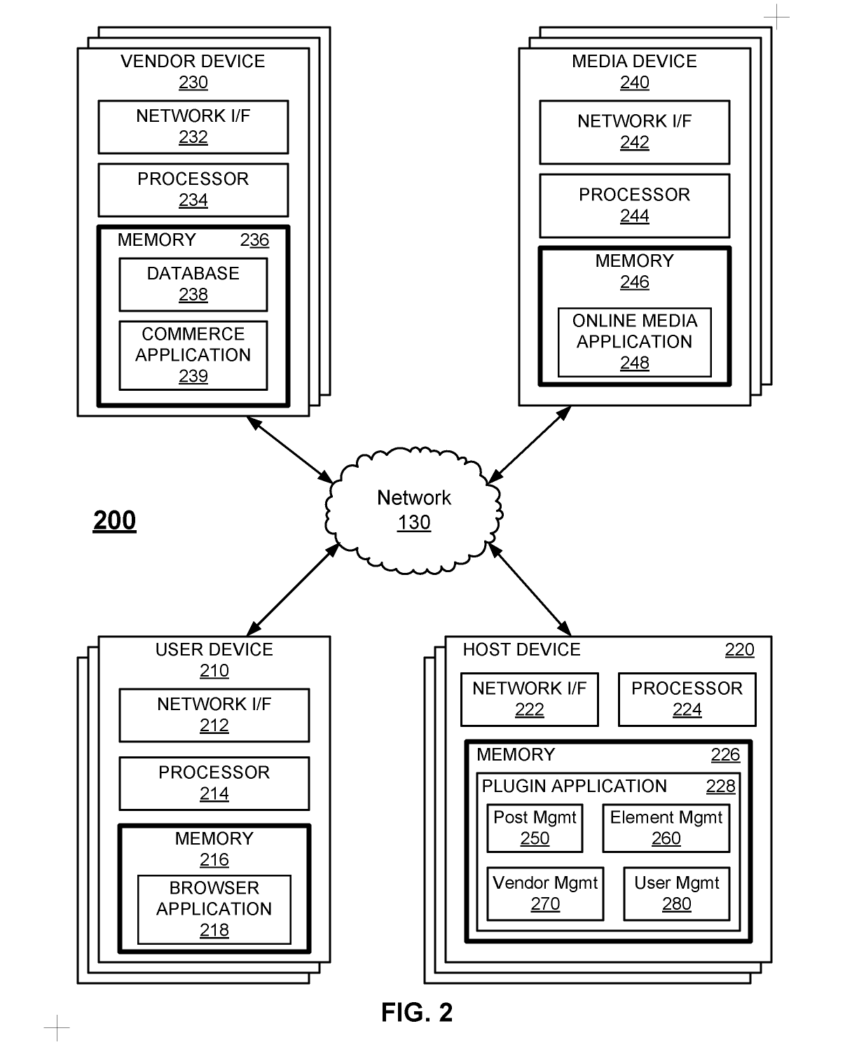

Turning now to the figures, FIG. 2 is a diagrammatic illustration of an example computer environment 200, consistent with embodiments of the present disclosure. In certain embodiments, the computer environment 200 can include one or more user devices 210, one or more host devices 220, one or more vendor devices 230, and one or more media devices 240. User devices 210, host devices 220, vendor devices 230, and media devices 240 are computer systems, such as computer systems 100 as described above. Although stacks of three user devices 210, three host devices 220, three vendor devices 220, and three media devices 240 are shown in FIG. 2 for purposes of illustration, it is to be understood that other embodiments may include less or more than three user, vendor, host, or media devices. User devices 210, host devices 220, vendor devices 230, and media devices 240 may be located separately from each other and communicate over a network 130. In some embodiments, host devices 220 comprise central hubs from which other devices (e.g., user devices 210 and vendor devices 230) can establish communication connections. Alternatively, the devices of FIG. 2 may be configured in any other suitable relationship (e.g., in a peer-to-peer or other relationship).

In certain embodiments the network 130 can be implemented using any number of any suitable communications topologies (e.g., wide area network (WAN), local area network (LAN), Internet, Intranet, hardwire, wireless link, etc.). In certain embodiments, the network 130 can be implemented within a cloud computer system, or using one or more cloud computing services. Consistent with various embodiments, a cloud computer system can include a network-based, distributed data processing system that provides one or more cloud computing services. In certain embodiments, a cloud computer system can include many computers, hundreds or thousands of them, disposed within one or more data centers and configured to share resources over the network. However, it is to be understood that cloud computer systems are not limited to those whose include hundreds or thousands of computers and can include few than hundreds of computers.

The media device 240 includes an online media application 248 on the media device 240 system memory 246. A processor 244 of the media device 240 executes instructions of the online media application 248. A network interface 242 of the media device 240 allows data transfer between the media device 240 and other devices on the network 130 as described herein. In certain embodiments, the online media application 248 hosts online media on the network 130 for other devices to access, for example allowing users to access the online media using user devices 210. Online media applications 248 host social media websites, news websites, e-commerce websites, or other types of websites. The online media applications host online media which includes online posts as described herein. Other configurations and uses of the online media application 248 are also possible.

The host device 220 includes a plugin application 228 on the host device 220 memory 226. A processor 224 of the host device executes instructions of the plugin application 228. A network interface 222 of the host device 220 allows data to transfer between the host device 220 and other devices of the network 130 as described herein. The plugin application 228 as depicted includes a variety of components, which may themselves be sub-applications of the plugin application 228. These components may manage separate aspects of the plugin application 228 as discussed herein. As depicted, the plugin application 228 includes a post management component 250 that manages posts of online media, an element management component 260 that manages individual elements of posts that have been identified as relevant online posts as used herein, a vendor management component 270 that manages interactions with a set of vendors, and a user management component 280 that manages interactions with a set of users.

The post management 250 component of the plugin application 228 may detect that the online post of the online media application 248 relates to a potential business enterprise as described herein. The post management component 250 analyzes the online post, identifying elements of the potential business enterprise as described herein. Monetizing an aspect of the online post as a business enterprise is possible using the identified elements. In some embodiments, the post management component 250 arranges the elements into a complete procedure which substantially replicates the online post. This procedure may be broken into different actions associated with the creation of the business enterprise (e.g., buy, rent, lease, ship, labor, etc.). Vendors using vendor devices 230 may interact with the post management 250 component over the network 130, adding new elements or actions into the procedure, and/or indicating an interesting in providing one or more element or action of the procedure.

In response to detecting that the online post relates to a potential business enterprise, the post management component 250 may flag the post as such. Flagging the post may include the host device 220 sending a notification to vendor devices 230 of known vendors which are related to the online post.

In certain embodiments, the plugin application 228 may be configured to autonomously create the ad-hoc supply chains in response to the detection of the online post. The plugin application 228 detects the online post from the online media application 248. In some embodiments, the plugin application 228 collects data from both vendor databases 238 and vendor commerce applications 239 and stores such data locally on the host device memory 226. Locally stored data may cross-reference vendors, vendor contractual specifications (e.g., prices, locations, or terms at which the vendor will provide goods or services), and respective goods and/or services of respective vendors. Locally stored data may be verified back to remote vendor devices 230 at predetermined intervals, such as once a day or once a week. Where data has changed or cannot be verified (e.g., as the corresponding data has been removed from the vendor database 238 or vendor commerce application 239) the plugin application 228 may remove/delete the local version of such modified/unverified data. Data from the online post is compared to both locally stored vendor data and data related user devices 210 that are viewing the online post using the plugin application. A set of vendors that matches the online post and user with a sufficiently high confidence score as described herein is provided in a GUI to the user device 210. In this way, in certain embodiments the plugin application 228 may autonomously provide ad-hoc supply chains to user devices 210 in real-time (e.g., within seconds of the online post being publically available on the online media application 248).

The vendor devices 230 can include vendor databases 238 and commerce applications 239 on the vendor device 230 system memory 236. A processor 234 of the vendor device 230 executes the instructions of the commerce applications 239. A network interface 222 of the vendor device 230 may allow the vendor device to send data to and receive data from other devices of the network 130. The vendor databases 238 may include vendor catalogs and inventories. Vendor catalogs and inventories may provide information on the products and/or services of respective vendors. Catalogs and inventories may be made available to the vendor management 270 feature of the plugin over the network 130 as described herein. Commerce applications 239 may include order management systems or billing systems, among other possibilities.

The vendor management component 270 of the plugin application 228 may manage and maintain data from the vendor devices 230 which is relevant to the online post. The vendor management component 270 may gather vendor data as described herein (e.g., using application programming interface or file transfer protocol methods), and integrate the data for the plugin application 228. Data may include legal and commercial information gained from the vendor, whether gained from a vendor database 238 or a commerce application 239. The vendor management component 270 may also maintain the history of elements and/or actions previously supplied and/or offered by vendors. For example, if the vendor previously offered to provide element “flour”, or element “sugar”, relating to an online post for baking cakes, or previously completed a sale through the plugin application 228 relating to action tag “buy,” the vendor management component 270 may store these previous acts. The vendor management component 270 may then use this history to match the vendor to a future element or action which is substantially similar to the previous historical element or action. Further, the vendor management component 270 may maintain any follow-up data from a user that engaged in a business relationship with the vendor, whether or not the business relationship was positive or negative. The follow-up data may take the form of an active write-up or a passive rating system (e.g., like versus dislike, a one-to-five rating, etc.).

The element management component 260 of the plugin application 228 may manage the integration of the elements of the online post and the corresponding offerings of vendors. The element management component 260 may use natural language processing (NLP) techniques to determine definitions and terms across regions of the globe, translating languages when necessary to match elements to vendor offerings across languages and vernaculars. The element management component 260 may also determine specific characteristics of elements, possibly differentiating between all-purpose flour and almond flour, for example, when both are offered by vendors. Likewise, the element management component 260 may determine necessary quantities of elements, determining and or projecting the requisite amount of an element for a business enterprise, and correlating this threshold amount with an offered amount by a vendor. The element management component 260 may use the NLP techniques to map back to a vendor database 238—which may or may not be locally stored by the vendor management component 270—to determine a price of the element as offered by the vendor.

A vendor sees an online post from the online media application 228 which is available on the network 130. The vendor may identify an element of the online post as an entity which the vendor provides as a business. For example, a post may relate to a baked good, and the vendor may provide an ingredient of the baked good. The vendor may then provide an indication using the vendor device 230 to the plugin application 228 of the host device 220. In some embodiments, the indication may be sent to the vendor management component 270 or the post management component 250. The indication indicates that the vendor is able to provide the relevant element as a part of a supply chain. In some embodiments, the indication is sent in response to the notification of the host device 220 described above. In other embodiments, the indication itself indicates that the post is a business enterprise. The indication may also create/provide/authorize a connection (e.g., a file transfer protocol (FTP) connection or an application programming interface (API) connection) from the plugin application 228 to the vendor databases 238 and/or commerce applications 239.

The plugin application 228 gathers indications relating to the online post from a plurality of vendor devices 230. The plugin application 228 associates all of the indications with the online post. The plugin application 228 stores data on the indications.

A user device 210 includes a browser application 218 on the user device 210 memory 216. The user device includes a processor 214 which executes the instructions of the browser application 218. A network interface 212 sends data to the network 130 on behalf of the user devices 210 and receives data for the user devices 210 from the network as described herein 130. A user uses the browser application 218 to browse online media while using the plugin application 228. The user sees the online post from the online media application 248. The user indicates, using the plugin application 228, an interest in the business enterprise of the online post of the online media application 248. The plugin application 228 may use data on the user to match the user to a set of vendors who have sent affirmative indications from vendor devices 230. The plugin application 228 may gather up-to-date data from the vendor databases 238. The plugin application 228 displays one or more ad-hoc supply chains using this data to the user on the user device 210 over the network. The plugin application may display the one or more supply chains in the same GUI in which the user device 210 is viewing the online media of the media device 240.

Consistent with various embodiments, each of the devices 210, 220, 230, 240 is implemented as a computer system including a respective set of system elements, such as the computer system 100 of FIG. 1. In certain embodiments, one or more device may be equipped with a respective display or monitor. In certain embodiments, each computer system may include communications devices (e.g., modem, network cards, etc.), input devices (e.g., a keyboard, mouse, or other input device), as well as commercially available and custom software (e.g., communications software, server software, natural language processing software, search engine and/or web crawling software, filter modules for filtering content based upon predefined criteria, etc.). Other system elements and configurations of devices of FIG. 2 are also possible.

In certain embodiments, each of the computer systems may be implemented as one of a server, desktop, laptop, or hand-held devices. In addition, the applications 218, 228, 239, 248 may include one or more modules or units to perform the various functions of embodiments described herein.

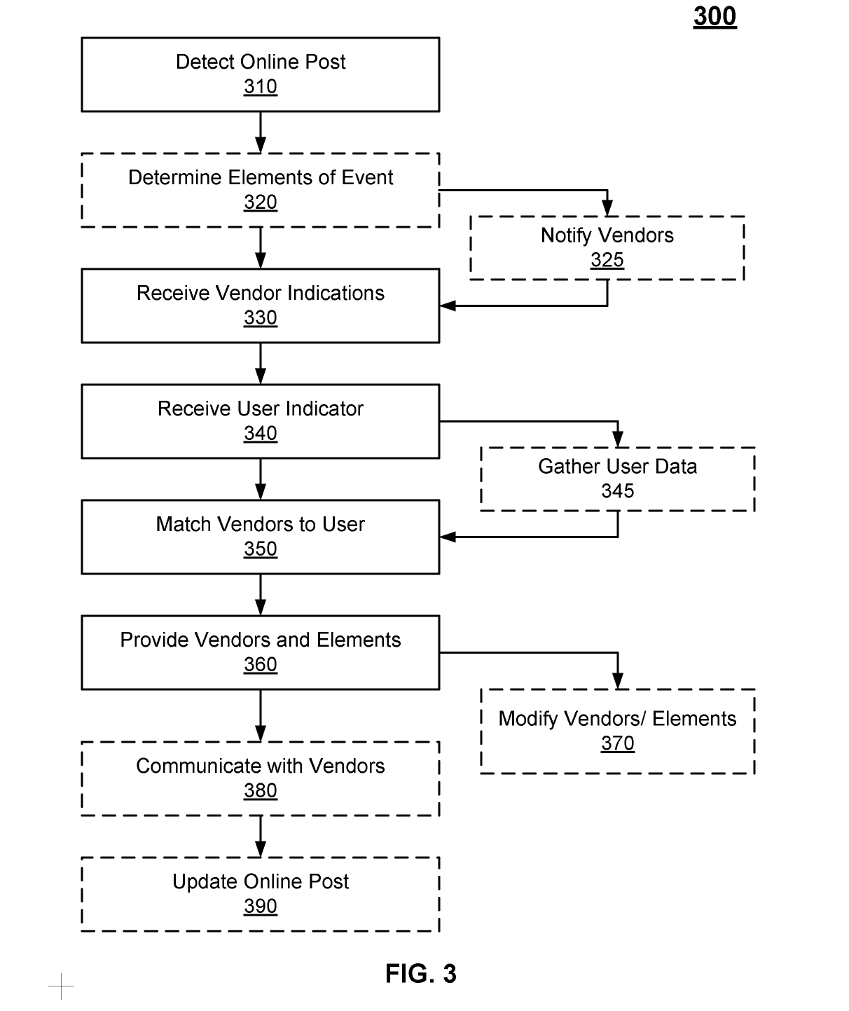

FIG. 3 is a flowchart illustrating a method 300 for the ad-hoc creation of supply chains. Supply chains are created by a supply chain software application which is developed as an extension or plugin to online media platforms, though the supply chain software application will be referred to as the plugin hereinafter for purposes of clarity. The online media platform and the plugin are hosted from separate computer systems, such as the computing system 100 as discussed above. A plurality of vendors communicate with the plugin from a plurality of separate computer systems such as computing system 100. Each of the plurality of vendor computer systems may include separate vendor databases and applications which communicate with the plugin. One or more users view the online media of the online media platform using the plugin from a separate user device such as computing system 100. Blocks with hashed lines in FIG. 3 are optional steps within method 300. The visual arrangement of blocks in the flowchart of FIG. 3 is not to be construed as limiting the order in which the individual acts/operations may be performed, as certain embodiments may perform the operations of FIG. 3 in alternative orders.

At block 310 an online post is detected. The online post is detected while being hosted by the online media platform. In some embodiments, the post is a social media post hosted on a social media platform (e.g., Facebook®, Google+®, etc.). In other embodiments, the post is a news post hosted by a news media platform (Yahoo®, MSN®, etc.). In other embodiments, the post is a commerce post hosted by an e-commerce media platform (eBay®, Amazon®, etc.). The online post may be text, video, audio, or some combination thereof.

The online post relates to a potential business enterprise. Specifically, the online post relates to a service or product with a set of elements, where the service or product may be monetized upon the acquisition/completion/processing of the set of elements. For example, an article on a type of cake may be posted on a social media platform. Being as this article identifies a product (e.g., cake) with a set of elements (e.g., a first element of flour, a second element of sugar, a third element of chocolate chips, etc.) which can be monetized as a business enterprise (e.g., bakery) with the help of vendors (e.g., food wholesale providers, shipping providers, etc.), the article can be detected as an online post as defined herein.

In certain embodiments, an online post may include only a single element. For example, the online post may relate to a method of creating some form of art, where the tools for creating the art are all assumed to exist within the living area of the user (e.g., a new-age art technique where sculptures are made from refuse around a house). For this online post, the single element may be a shipping element to send the finished pieces to buyers around the world. In any such online post, the set of elements may be thusly identified as a single element.

The online post may be detected by the plugin. The plugin may detect the online post in response to the online post being posted in a public or semi-public manner (e.g., in a manner such that all or most users of the online media may access the online post). In some embodiments, the plugin analyzes posts which match a set of criteria, and if the posts relate to a potential business enterprise, the plugin detects the post as an online post as defined herein. The set of criteria may include the post being posted with a certain amount of visibility (e.g., being posted on the “front page” of a news website) or being posted by certain entities predetermined to regular post potential business enterprises. In other embodiments the plugin may simply analyze all new posts of a media platform.

In embodiments where the online post is text, the plugin may analyze the language of the text. In embodiments where the post includes data other than text (e.g., video, audio, images), known techniques may be used to convert the other data into text. Alternatively, where the post includes data other than text, the data of the post may be gathered from a description of the post or from known techniques to recognize locations/images/shapes where the data is a video/image post. The content of the online post may be determined using known natural language processing techniques. Natural language processing (NLP) techniques can include, but are not limited to, semantic similarity, syntactic analysis, and ontological matching. For example, in some embodiments, a natural language processor could be configured to parse posts to determine semantic features (e.g., word meanings, repeated words, keywords, etc.) and/or syntactic features (e.g., word structure, location of semantic features in headings, title, etc.). Ontological matching could be used to map semantic and/or syntactic features to a particular concept. The concept can then be used to determine the subject matter. Using NLP techniques, the plugin may classify the concepts of the post as including a product or service with a set of elements which may be monetized.

In some embodiments, the online post is detected by a user of the plugin. A user as used herein is an entity which is a consumer of the online media and a user of the plugin and will pursue a business enterprise from an online post of the online media. A user that detects the online post may use the plugin to flag the post as an online post as defined herein. In response to the user flagging the post as an online post, the plugin may detect the online post.

In some embodiments, the online post is detected by a vendor. A vendor as used herein is a business entity which provides goods and services which can support the potential business enterprise. Services may include such details as shipping goods, storing goods, and renting office/work space, among other possibilities. A vendor that detects the online post may use the plugin to flag the post as an online post as defined herein. In response to the vendor flagging the post as an online post, the plugin may detect the online post.

At block 320 the plugin determines the set of elements of the online post. The elements include the disparate components or steps necessary to monetize the product or service of the online post. The plugin determines the elements using NLP techniques as described herein. The plugin may also determine a category of the set of elements using NLP techniques as described herein. The category may be the commercial industry (e.g., agriculture, food, tourism, beauty, hardware, labor etc.) of the element, or the action (e.g., buy, rent, lease, ship) associated with the element.

For example, a video of a person making a cake may be posted to a social media platform. The plugin may detect that this video is an online post in block 310. On top of general service elements (e.g., a shipping element or a hired chef element), the plugin may detect elements of cocoa powder, sugar, canola oil, eggs, butter, flour, salt, eggs, vanilla, buttermilk, baking soda, and vinegar. The plugin may further determine a category of “buy food” for these elements.

In some embodiments, the plugin detects that multiple alternative elements of the online post relate to a single service/element/step, wherein the multiple alternative elements are mutually exclusive. For example, the video may suggest that buttermilk can be substituted for milk with lemon juice. As such, the plugin may also list milk and lemon juice as alternates to buttermilk. The plugin may store (and later present) these elements in such a way as to make clear that said elements are substitutes for each other rather than each being independently required or desired.

In some embodiments, the plugin determines characteristics of each element. Characteristics of elements may include the quantity of a particular element or general aspects of the element. For example, using the cake example above, the element “eggs” may have a quantity of two per cake and a characteristic of “large” and “organic” within the online post.

In certain embodiments, the plugin updates elements, element categories, and/or element characteristics. The plugin may update the elements by accepting input from users or vendors of the plugin. The plugin may use this user/vendor input to add new elements, add characteristics to existing elements, or revise current elements or characteristics. In some embodiments, the plugin updates the elements/element characteristics when the user/vendor input has a confidence score which satisfies a threshold. Vendor/user input may have a confidence score which satisfies a threshold as a result of receiving a certain number/percentage of responses (e.g., where 25% of vendors that inspect the online post provide the input) or as a result of receiving the input from a qualified vendor/user (e.g., the input originated from a vendor who has been previously validated as providing accurate input). For example, the plugin may determine that the online post “bake cake” includes the element “sugar.” The plugin may receive vendor input on element “sugar” (e.g., input in response to block 325 where elements are provided to the vendor) providing a characteristic of “white sugar” from an image which accompanied the text/audio (e.g., audio stating to add two cups of sugar along with images of white sugar being measured/added to mixture).

In certain embodiments, the plugin determines vendors who provide support for the elements of the online post. Support vendors may include vendors who provide shipping services, warehouse services, or commercial space services, among other possibilities. The plugin may include such support by default, regardless of whether or not an online post included information alluding to the need of support vendors. The plugin may allow a user to remove such vendors as desired within block 370, where vendors are modified.

At block 330 a set of vendor indications are received. Vendor indications are sent from respective vendors. The vendor indications indicate whether or not the vendor can provide one or more elements of the online post. The plugin receives the vendor indications. The plugin may receive a plurality of vendors for each element of the online post.

For example, using the cake example above, the plugin may receive five affirmative indications from individual flour vendors regarding the ability of said five vendors to provide the flour specified in the online post. By receiving such affirmative indications directly from vendors, the plugin may increase the confidence scores of matches between vendors and elements.

The vendor indications may also provide data of either a database of the vendor or a commerce application (e.g., billing management application, order management application, etc.) of the vendor. For example, the database may include a catalog of the vendor and/or an inventory of the vendor, and the vendor may send an indication relating to a first element of the online post. In this example, the vendor indication may include a connection which the plugin may use to access the database and/or commerce application of the vendor device. For example, the vendor indication may include an indication that the vendor is willing to provide the element, and FTP or API data which the plugin may utilize to access catalog, inventory, billing, or order information to gather any desired information on the first element. In other embodiments, the vendor may include an element number from the catalog which relates to the first element and a supply of the element from the inventory which relates to the first element.

Vendor indications may include parameters upon the ability/inclination of the vendor to sell the respective element. Sale parameters may be gathered from the vendor database and/or commerce applications as described above. Sale parameters may include a geographical range, contractual limits, a possible minimum order quantity, payment terms, or price ranges within which the vendor will provide certain elements. For example, a foodstuff vendor may send an indication for a first element Sugar and a second element Flour of an online post relating to a cake. The vendor indication may include, for example, a range of the pacific northwest of the United States in which orders for either Sugar or Flour would be accepted, and arbitration clauses and damage limitations which must accompany a particular sale. The vendor indication may also include a first price range for Sugar and a second price range for Flour.

A vendor indication may include a basic business deal for one or more of the elements. This business deal may be gathered from the vendor database and/or commerce application as described above. The basic business deal may be between the vendor and an unspecified future customer (e.g., the user of the plugin). This business deal may then be completed by the user when it is provided by the plugin as described below at block 360, such that all that is required is final approval by the vendor below at block 380. In some embodiments the business deal may be altered by the vendor as desired during communication between vendor and user using the plugin at block 380.

In certain embodiments the plugin may receive additional elements from the vendor at block 330. The additional elements may be for extra elements for the business enterprise as recommended by the vendor (e.g., extra ingredients in a recipe). The plugin may add these extra elements to the set of elements. In some embodiments, the plugin sends new notifications for these additional elements to additional vendors as described below in block 325. In embodiments where the additional vendors are matched with the additional elements, the plugin may track the vendor which originally suggested the additional element.

In some embodiments, the vendor indications are sent in response to a notification from the plugin. The plugin may send vendors notifications at block 325. The notifications may include details on the online post, such as the nature of the detected potential business enterprise and a detected set of elements of the online post. The plugin may notify vendors after detecting the online post at block 310 and determining the elements of the online post at block 320. In some embodiments, the plugin may have a master set of vendors which includes all known/registered vendors. For example, each vendor of the master set of vendors may register with the plugin as a vendor of certain elements. In response to determining the elements of the online post at block 325, the plugin may determine a subset of vendors who match the determined elements, and send a notification of the online post to said subset of vendors.

For example, using the cake example above, the plugin may determine that ten flour vendors match a Flour element. In response to determining this match, at block 325 the plugin sends these ten flour vendors a notification which includes the video of the cake being made and the extracted possible sale of 3 cups of flour per cake. Following this, at block 330 the plugin may receive two declination of matches, five affirmative matches, while getting no response from three vendors. In some embodiments, a vendor may signify an affirmative match with an element by “highlighting” the corresponding element. As a result, at block 350, the plugin may provide the five flour vendors to the Flour element with a high confidence score, while also providing the three flour vendors to the Flour element with a relatively lower confidence score.

The plugin may match vendors to elements based on a calculated ability and/or inclination on the part of the vendors to provide the elements. Numerous vendors may match a single element, and a single vendor may match numerous elements. The plugin may match vendors to elements when the relationship between vendor and element satisfies a certain confidence score. A confidence score may be impacted by such things as the similarity between the element and the product/service of the vendor as determined by NLP techniques, the rating of the vendor (e.g., as rated by plugin users or the third-party agencies typically known for providing business ratings), or the number of times the vendor has previously successfully provided substantially similar elements using the plugin. Other factors may also impact the confidence score of a match between a vendor and element.

The plugin may track and learn from the responses received from vendors at block 330. For example, the plugin may learn trends as to which elements a vendor typically affirmatively matches/declines to match/ignores. The plugin may also learn which types of online posts (e.g., text, video, audio, etc.) a particular vendor is most likely to respond to. The plugin may learn whether a particular vendor is more or less likely to respond to a notification based on the original source of the online post (e.g., an event originally posted by a corporation, versus an event posted by a social media user with a relatively high number of followers/subscribers, versus an event posted by a social media user with a relatively low number of followers/subscribers). The plugin may learn how the social media activity surrounding the online post (e.g., how often the post has been liked/disliked/shared/visited, etc.) impacts how a particular vendor will respond.

The plugin may use these factors to better match vendors for specific elements. Additionally, the plugin may alter a confidence score on a vendor (e.g., a vendor who does not typically respond to this “type” of post may be given a lower confidence score as a result) to improve the accuracy of the ad-hoc creation of supply chains. Alternatively, the plugin may use these factors to advertise/commercialize an underlying online post on the social media platform.

In some embodiments, the plugin may learn vender patterns/preferences not from vendor indications at block 330 but instead from alternate locations within method 300, such as during communication with the vendor at block 380.

At block 340 a user indicator is received. The user indicator indicates an interest of the user in the business enterprise. The user indicator is sent by a user using a separate computing device to view the online media which includes the online post. The user utilizes the plugin when viewing the online post to transmit the user indicator.

For example, the user may see a video for a new way to wash a car. The user may also see a button near the post indicating that the plugin has identified this post as a potential car washing enterprise. The user may therefore click the button to activate the plugin to create an ad-hoc supply chain for this enterprise. The plugin may detect this user indication.

At block 350 a set of vendors is matched to the user providing the user indicator. The set of vendors are matched specific to the user. Vendors are matched to the user using sale parameters such as location, rate, or time. These sale parameters may indicate when a vendor can provide an element, such that a vendor may be able to provide an element in a specific physical region (e.g., the region at which the element will be provided/delivered) at a specific range of prices within a specific timeframe (e.g., a timeframe during which the element may be ordered or timeframe between ordering and arrival of element) while not being able to provide the element outside of that region/price range/timeframe. For example, a United States potato vendor may be able to provide potatoes to the Pacific Northwest at a price of $2,000 per ton from April to November every year, while not being willing/able to provide potatoes outside of that region/price/timeframe. As a result, a first user in Oregon looking at a potato soup post may be matched to the Pacific Northwest potato vendor, while a second user in Ireland looking at the same potato soup post may be matched to an Irish potato vendor. In this way, different users may be matched to different vendors for the same online posts, providing customized data on ad-hoc supply chains in the centralized GUI by utilizing decentralized data.

The plugin may gather user characteristics at block 345 to gauge the ability of a vendor to provide an element. User characteristics may include an operating address of the user or a preferred cost of the user, among other possibilities. Users may provide user characteristics during an initialization phase where the user is registering with the plugin. Other methods known to one of skill in the art for getting user characteristics as used herein are also possible. The plugin may match a vendor to a user as long as the user characteristics correspond with vendor availability. For example, at block 330 the potato vendor above may be determined to be one of many conditionally able vendors. However, at block 345, the plugin may receive user characteristics including an address in Texas and a price of $1,800 per ton. Using this gathered user data, the plugin determines that the potato vendor above does not match this user. The plugin may therefore remove this vendor from the set of vendors.

In certain embodiments the plugin may regularly check the vendor database to ensure that matches should not be altered due to database updates. For example, the plugin may have matched a first product of a vendor to an element. The vendor may then update a database to alter the first product. The plugin may recheck the database and determine that the altered first product no longer matches the element. In response to this, the plugin may remove the vendor from the list of matches to the element. For example, using the car wash example above, the plugin may have matched a soap vendor to the car soap element. The plugin may have matched the soap vendor to the element using an indication from the vendor which included an API connection to the vendor database. The soap vendor may then delete the car soap entry, leaving no car soap entries within the database. The plugin may detect this and may remove the correlation of this particular soap vendor from the set of vendor matches to the car soap element.

At block 360 vendors and elements are provided to the user. The elements and vendors may be structured to resemble a complete supply chain. The set of vendors may include information from each vendor on the available quantity and type of elements said vendor may provide. The set of vendors may also include terms of the deal for individual vendors, such as minimum order quantity, payment timelines, or delivery options.

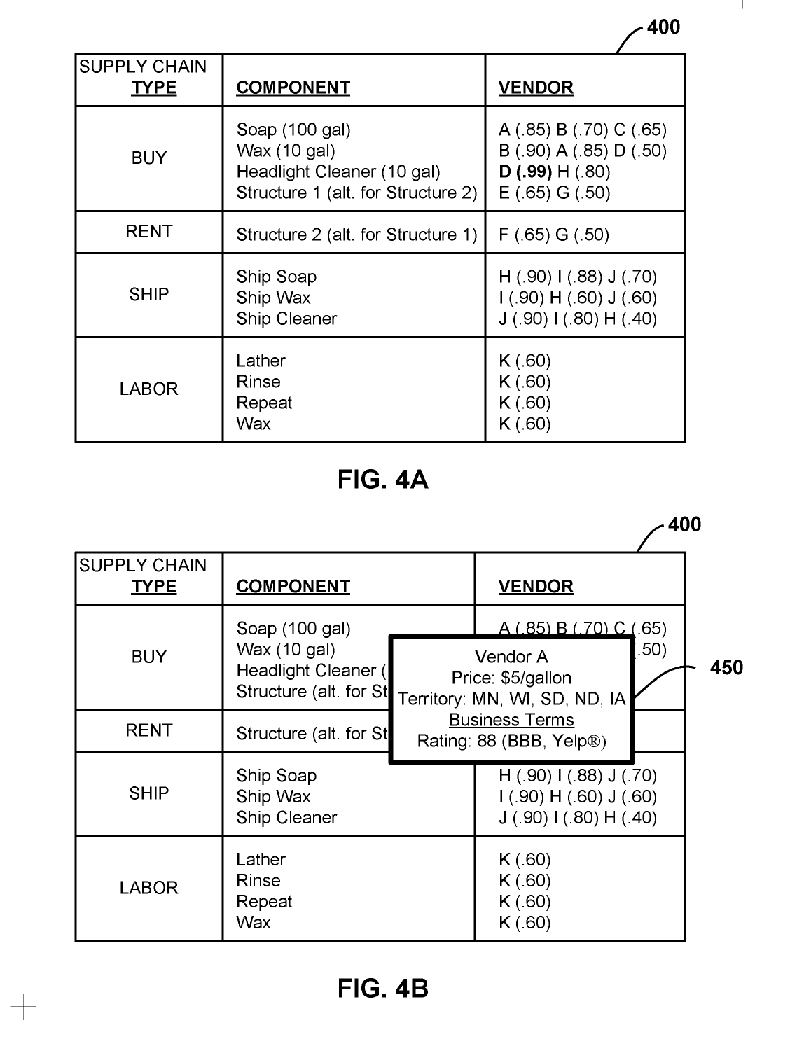

For example, using the car washing enterprise above, the plugin may provide information relating to elements of soap to buy, wax to buy, shipping companies for said soap and wax, available structures to rent, and available structures to buy, among other elements. The plugin may additionally provide a suggested element of a proprietary headlight cleaner, which was not in the original post but was instead suggested by a vendor at block 330. The suggesting vendor may be credited with the suggestion (e.g., as shown in FIG. 4A, where vendor D originally suggested the headlight cleaner and is therein bolded within the GUI). The plugin may also include steps from the original post of the online post which did not have a corresponding element. For example, when the plugin provides information on the car wash supply chain above, the information may include “lather”, “rinse”, “repeat”, and “wax” steps to further compress data into a single source to improve data fidelity through the process.

The provided set of vendors may include ranks of the vendors. The vendor ranks may be associated with the confidence scores calculated when matching the vendors to elements for the user at block 350. The plugin may provide information on how the confidence scores were calculated.

In some embodiments, the set of elements may be arranged by category of elements. For example, washing elements may be displayed differently than shipping elements, which may themselves be displayed differently than hardware elements. In other embodiments, the elements and vendors may be arranged by relationships between vendor and user (e.g., renting relationship, buying relationship, touring relationship, selling relationship, dining relationship, shipping relationship, etc.). By displaying different types of information in different ways, the plugin may be able to quickly alter, remove, or minimize a type of element or vendor in response to user input.

The plugin may provide ad-hoc supply chains within a GUI 400 such as is depicted in FIG. 4A. The GUI 400 as depicted is within the GUI of the online media in some embodiments. For example, in response to the plugin detecting the user prompting the display of ad-hoc supply chains, the plugin may insert the GUI 400 depicted immediately adjacent to the display of the online post.

The GUI 400 depicts elements broken down by the action associated with the element. For example, as depicted in FIG. 4A, elements which may be bought (e.g., elements which have an action of “buy”) are visually presented at the top of the GUI 400, elements which may be rented (e.g., elements which have an action of “rent) are visually lower, while shipping elements (e.g., elements which have an action of “ship”) are visually lower, while elements associated with physical labor (e.g., elements which have an action of “labor”) are visually presented at the bottom of the GUI 400.

The GUI 400 may also provide data on the elements of the online post. As determined at block 320, the GUI 400 depicts physical components of 100 gallons of soap, 10 gallons of wax, 10 gallons of headlight cleaner, shipping for the physical components, a physical structure in which the enterprise can be housed, and the steps/operations of the online post. As depicted in the GUI 400, the plugin may provide data when elements are substitutes, such as structure 1 and structure 2, which are displayed as alternates for each other.

The GUI 400 may also provide vendors which correspond to the elements. The vendors may be arranged in term of the score of the match between vendor, elements, and user as determined at block 350 of FIG. 3. As shown in the GUI 400, the score of a match may be depicted as a confidence score out of 1.0, though other manners of evaluating and displaying evaluations are also possible. If a vendor suggests a specific element (e.g., an element originated not from the online post but from a vendor who recommended supplementing a business of the online post with said element), the vendor may be acknowledged as such, such as shown in GUI 400 where vendor D is bolded within the headlight cleaner row as a result of vendor D originating the idea of using the headlight cleaner.

As discussed herein, at times individual vendors may change what elements they offer and under what terms said elements are offered at remote vendor devices, at which point the plugin may detect the update and recalculate/evaluate accordingly. In this way the plugin may provide decentralized control of a centralized display at a set online location. In other words, the embodiments described herein enable the integration of separate systems over a network to allow a user to direct the creation of an ad-hoc supply chain while also enabling a supplier to influence the creation of the ad-hoc supply chain. For example, the user can direct the creation of the ad-hoc supply chain based on options provided by the plugin. A supplier can simultaneously retain control over the catalog of products/services provided, set/modify business terms, and provide options for the elements provided by the plugin for the ad-hoc supply chain.

In some embodiments, the GUI 400 is configured to allow a user bring up a display within the GUI 400 with more information on one or more vendors of the GUI. FIG. 4B depicts an illustration of a GUI 400 with created ad-hoc supply chains with additional vendor information on vendor A. FIG. 4B depicts the additional information on vendor A as shown in a pop-up window 450 within the GUI 400. The depicted window 450 displays the price, sales territory, and business terms at which vendor A will provide the respective element. As depicted within the window 450, the business terms are a hyperlink which will bring up a display with the respective business terms. The window 450 may also display a calculated rating of the vendor with regards to the respective element, as calculated from various sources (e.g., previous buyers of the element from the vendor, online reviews, the BBB, etc.). The window 450 may provide the sources of the rating as depicted. In some embodiments, rather than displaying additional vendor data through a window 450 as depicted in FIG. 4B, vendor data may be displayed by “drilling into” the GUI 400. Other methods of providing additional data known to one skilled in the art are also possible. Hence, the embodiments described herein enable the display of options to create an ad-hoc supply chain via the same GUI which provides the post being viewed by the user.

Looking back to FIG. 3, at block 370 the plugin may modify the set of elements and associated matching vendors. The plugin may modify the elements and vendors in response to user input. For example, using the car wash example above, the plugin may detect that the user has selected to rent rather than buy a structure, while the user has also elected to pursue the proprietary headlight cleaner. In response to this, the plugin may remove vendors for buying structures, while displaying vendors for proprietary headlight cleaner.

The plugin may respond to a user request to drill down into an element by displaying a submenu of associated vendors. The plugin may further respond to a user request to drill down into vendors by displaying another submenu which includes product/service details related to a particular vendor's version of the element and deal parameters for the particular vendor. The plugin may construct and display complete supply chains with different combinations of vendors in response to the user's requests, totaling up prices and times associated with the deal parameters of the vendors in a given supply chain combination. The plugin may provide a rank or score of a completed supply chain using the confidence scores of vendors within the completed supply chain as calculated at block 330.

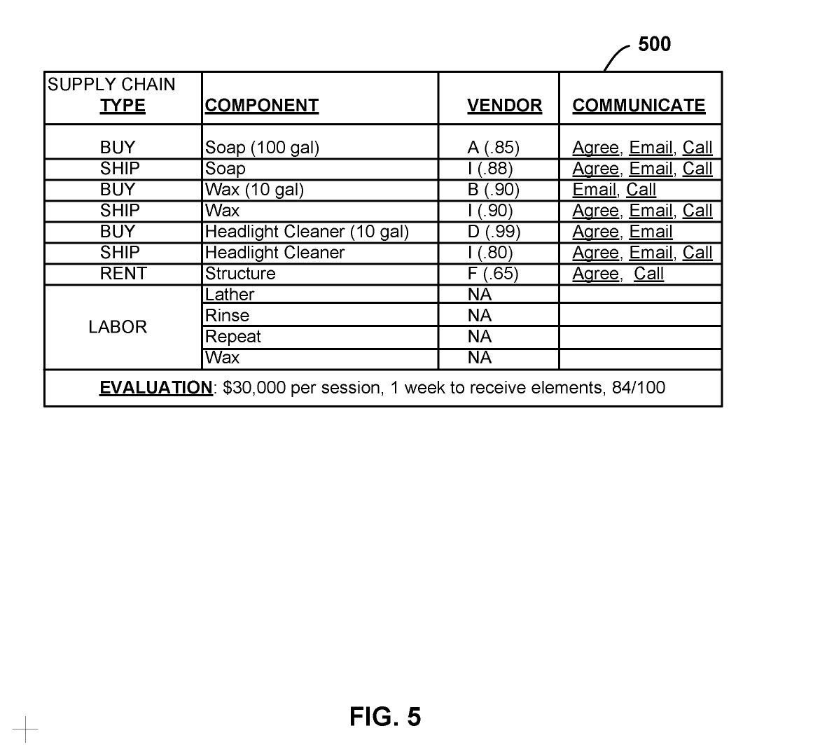

For example, FIG. 5 depicts a GUI 500 with a final selection of vendors as selected by a user. The GUI 500 relates to the car wash example used above, and the vendors as depicted were selected from GUI 400 of FIG. 4A. The GUI 500 includes each selected element and the selected action associated with it in order. The GUI 500 also provides a final evaluation of the selected ad-hoc supply chain as described above, with costs, timelines, and scores associated. As depicted in GUI 500, even though a user decided to forgo vendors for some elements (e.g., the elements with the labor action-tag), the GUI 500 still displays the elements to maintain context.

At block 380 the plugin may communicate with vendors. The plugin may communicate with the vendors that the user has chosen to pursue. The user may have accepted contractual business agreements of the vendor. These acceptances of the user may indicate a willingness of the user to satisfy/be bound to the contractual specifications of the vendor in regards to a future business deal between the user and the vendor. The plugin may communicate these business deal acceptances as selected by the user to the vendor. The business deals may be the business deals gathered from the vendor database and/or commerce applications as a result of the vendor's indication at block 330. The communication may be sufficient for the user and the vendor to enter a legally binding contract over the element. In other embodiments, the user may indicate a willingness to satisfy contractual specifications of the vendor by other acts that are detectable by the plugin (e.g., the user visiting a website of the vendor or a competitor of the website a threshold number of times, the user spending a threshold amount of time on the website of the vendor or a competitor of the vendor during one or more visits, the user favorably mentioning the vendor on a social website, etc.). A vendor may receive these indications of willingness to satisfy contractual specifications from the plugin. The plugin may receive a targeted business deal from the vendor tagged for the user. The plugin may display the targeted business deal for the user through the GUI, from which the user may accept the business deal of the vendor as described herein. In some embodiments, the plugin may assist the user in initiating review of the completed supply chain with different entities, such as an original entity which posted the online post, before placing the final order.

For example, as shown in FIG. 5, in a final selected ad-hoc supply chain, a GUI provided by the plugin may provide options to agree to a boilerplate set of conditions from a respective vendor, to email with a respective vendor, and/or to call a respective vendor. In some embodiments, a vendor may not have enabled all methods of communication. For example, as shown in FIG. 5, vendor B does not have an option to agree with a standing offer to provide wax, while vendor D does not have an option to call regarding buying headlight cleaner, and vendor F does not have an option to email regarding renting a structure in which cars may be washed. Such vendor options may have been purposefully removed/disabled by the vendors themselves who do not wish to agree to business terms, receive calls, or receive emails through the plugin. Alternatively, the relevant data (e.g., boilerplate contract data, email address data, phone number data) may have been unavailable for the plugin to pull from a vendor database.

At block 390 the presentation of the online post may be updated by the plugin. The post may be updated to include new elements which were identified through method 300, such as new parts (e.g., new ingredients in a food recipe) or new services. General business proposals identified may also be included in the original post, such as suggested markets or customers.

In some embodiments, ad-hoc supply chains provided by the plugin which resulted in accepted business deals may be displayed within the GUI. For example, a first user may see an online post and request ad-hoc supply chains. The first user may select vendors of the provided ad-hoc supply chains and enter into business deals with said vendors through the plugin. The plugin may provide details of this successful creation of a realized supply chain from the ad-hoc supply chain. The plugin may provide data that allows a second user to analyze the realized supply chain (e.g., costs, quantities, terms, etc.). In some embodiments, the plugin may offer determined ad-hoc supply chains for a first user to a second user before any ad-hoc supply chains have been realized by the first user (e.g., displaying one or more ad-hoc supply chains that were generated for a first user to a second user before the first user accepts any/all terms/agreements of the generated ad-hoc supply chains). The plugin may provide the second user the option to accept substantially similar business deals. In certain embodiments, the plugin may grant the second user to quickly modify the realized supply chain before accepting deals, such as described in relation to block 370. In response to receiving acceptances from the second user, the plugin may communicate with respective vendors, to facilitate additional business deals. In this way, a first supply chain realized from an ad-hoc supply chain may beget a second realized supply chain, and so forth.

The functionality outlined in the discussions herein regarding FIG. 1, FIG. 2, and FIG. 3, FIG. 4A, FIG. 4B, and FIG. 5 above can be implemented using program instructions executed by a processing unit, as described in more detail below.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of creating ad-hoc supply chains from online media, the method comprising:
detecting an online post, wherein the online post includes online media from an online media platform, wherein the online post corresponds to a business enterprise and includes both a first element and a second element;
determining the first element and the second element of the online post using natural language processing techniques;
receiving a first set of vendor indications from a first set of vendors for the first element and a second set of vendor indications from a second set of vendors for the second element, wherein vendor indications indicate that the respective set of vendors have an ability and inclination to provide commercial offerings that correspond to the respective element;
receiving, from a first user that has first user characteristics, a prompt to create ad-hoc supply chains for the business enterprise for the first user; and
providing a first set of ad-hoc supply chains that match both a first subset of the first set of vendors to the first element for the first user and a second subset of the second set of vendors to the second element for the first user, wherein the set of ad-hoc supply chains is provided within a graphical user interface (GUI) of the online media platform using an online media platform plugin.

2. The method of claim 1, further comprising:
identifying, from a master set of vendors, a potential set of vendors that provide commercial offerings which correspond to either the first element or the second element, wherein the potential set of vendors includes the first and second set of vendors; and
sending a notification to the potential set of vendors.

3. The method of claim 1, further comprising:
gathering sale parameters from one or more remote devices of vendors of the first and second set of vendors in response to receiving the first and second set of vendor indications;
comparing the first user characteristics to the sale parameters; and
identifying the first subset of the first set of vendors and the second subset of the second set of vendors, wherein both the first and second subsets include sale parameters that are satisfied by one or more first user characteristics.

4. The method of claim 3, wherein the sale parameter is a geographical territory in which the vendor provides commercial offerings, wherein the first user characteristics includes a user address within the geographical territory.

5. The method of claim 3, wherein the sale parameter is a contractual specification of the vendor, wherein the first user characteristics indicate a willingness to satisfy the contractual specification.

6. The method of claim 1, wherein the online post includes a third element that is an alternate element for the second element such that the second and third elements are mutually exclusive.

7. The method of claim 6, further comprising receiving, from the first user, a selection of the second element, such that the second element and not the third element is provided within the first set of ad-hoc supply chains.

8. The method of claim 1, further comprising:
receiving, from a second user that has second user characteristics, a prompt to create ad-hoc supply chains for the second user; and
providing a second set of ad-hoc supply chains that match both a third subset of the first set of vendors to the first element for the second user and a fourth subset of the second set of vendors to the second element for the second user, wherein the second set of ad-hoc supply chains is provided within a graphical user interface (GUI) of the online media platform using the online media platform plugin.

9. The method of claim 1, the method further comprising:
receiving, from the first user, a selection of both a first vendor of the first subset of the first set of vendors and a second vendor of the second subset of the second set of vendors;
gathering a first contractual business offer that relates to a sale of the first element from a vendor device of the first vendor;
gathering a second contractual business offer that relates to a sale of the second element from a vendor device of the second vendor;
receiving acceptances from the first user to both the first contractual business offer and the second contractual business offer; and
sending the acceptances from the first user to the first vendor and the second vendor;
updating a presentation of the online post in response to sending the acceptance to the first and second vendors, wherein updating the presentation includes providing details of the first and second contractual business offers;
receiving, from a second user, acceptances of the first and second contractual business offers; and
sending the acceptances from the second user to the first vendor and the second vendor.

10. The method of claim 1, further comprising generating both a first set of confidence scores for the matches of the first subset of the first set of vendors to the first element for the first user and a second set of confidence scores for the matches of the second subset of the second set of vendors to the second element for the first user, wherein the first and second sets of confidences scores are provided for the user and displayed by the GUI.

11. A method of creating ad-hoc supply chains from online media, the method comprising:
detecting an online post, wherein the online post includes media from an online media platform that both corresponds to a business enterprise and includes a set of elements;
determining the set of elements of the online post using natural language processing techniques;
identifying a set of vendors that correlates with the set of elements using confidence scores, wherein the set of vendors provide commercial offerings that correspond to the set of elements; and
providing, in response to detecting the online post, the set of vendors and the set of elements to a user of the online media platform within a graphical user interface (GUI) of the online media platform using a software plugin for the online media platform.

12. The method of claim 11, further comprising:
gathering data from remote vendor databases to create a local database of vendor data, wherein the local database cross-references vendors and vendor contractual specifications to products or services supplied by vendors; and
verifying, using the remote vendor databases, data of the local database of vendor data at predetermined intervals.

13. The method of claim 11, wherein identifying the set of vendors includes:
gathering, from a master set of vendors; a group of vendors that correspond to the set of elements;
gathering data on the user;
analyzing the group of vendors based on the data of the user; and
selecting the set of vendors as having confidence scores that satisfy a threshold score.

14. A computer system comprising:
a memory; and
one or more processing circuits communicatively coupled to the memory, wherein the one or more processing circuits are configured to:
detect an online post, wherein the online post includes online media from an online media platform, wherein the online post both corresponds to a business enterprise and includes both a first element and a second element;
determine the first element and the second element of the online post using natural language processing techniques;
receive a first set of vendor indications from a first set of vendors for the first element and a second set of vendor indications from a second set of vendors for the second element, wherein vendor indications indicate that the respective set of vendors have an ability and inclination to provide commercial offerings that correspond to the respective element;
receive, from a first user that has first user characteristics, a prompt to create ad-hoc supply chains for the business enterprise for the first user; and
provide a first set of ad-hoc supply chains that match both a first subset of the first set of vendors to the first element for the first user and a second subset of the second set of vendors to the second element for the first user, wherein the set of ad-hoc supply chains is provided within a graphical user interface (GUI) of the online media platform using an online media platform plugin.

15. The computer system of claim 14, wherein the one or more processing circuits are further configured to:
identify, from a master set of vendors, a potential set of vendors that provide commercial offerings which correspond to either the first element or the second element, wherein the potential set of vendors includes the first and second set of vendors; and
send a notification to the potential set of vendors.

16. The computer system of claim 14, wherein the one or more processing circuits are further configured to:
gather sale parameters from one or more remote devices of vendors of the first and second set of vendors in response to receiving the first and second set of vendor indications;
compare the first user characteristics to the sale parameters; and
identify the first subset of the first set of vendors and the second subset of the second set of vendors, wherein both the first and second subsets include sale parameters that are satisfied by one or more first user characteristics.

17. The computer system of claim 16, wherein the sale parameter is at least one of:
a geographical territory in which the vendor provides commercial offerings, wherein the first user characteristics includes a user address within the geographical territory;
or a contractual specification of the vendor, wherein the first user characteristics indicate an inclination to satisfy the contractual specification.

18. The computer system of claim 17, wherein the online post includes a third element that is an alternate element for the second element such that the second and third elements are mutually exclusive.

19. The computer system of claim 14, wherein the one or more processing circuits are further configured to generate both a first set of confidence scores for the matches of the first subset of the first set of vendors to the first element for the first user and a second set of confidence scores for the matches of the second subset of the second set of vendors to the second element for the first user, wherein the first and second sets of confidences scores are provided for the user and displayed by the GUI.

20. A computer program product for the ad-hoc creation of supply chains, the computer program product disposed upon a computer readable storage medium, the computer program product comprising computer program instructions that, when executed by a computer processor of a computer, cause the computer to:
detect an online post, wherein the online post includes online media from an online media platform, wherein the online post both corresponds to a business enterprise and includes both a first element and a second element;
determine the first element and the second element of the online post using natural language processing techniques;
receive a first set of vendor indications from a first set of vendors for the first element and a second set of vendor indications from a second set of vendors for the second element, wherein vendor indications indicate that the respective set of vendors have an ability and inclination to provide commercial offerings that correspond to the respective element;
receive, from a first user that has first user characteristics, a prompt to create ad-hoc supply chains for the business enterprise for the first user; and
provide a first set of ad-hoc supply chains that match both a first subset of the first set of vendors to the first element for the first user and a second subset of the second set of vendors to the second element for the first user, wherein the set of ad-hoc supply chains is provided within a graphical user interface (GUI) of the online media platform using an online media platform plugin.

21. The computer program product of claim 20, the computer program product further comprising instructions which, when executed by the computer processor, cause the computer to:
identify, from a master set of vendors, a potential set of vendors that provide commercial offerings which correspond to either the first element or the second element, wherein the potential set of vendors includes the first and second set of vendors; and
send a notification to the potential set of vendors.

22. The computer program product of claim 20, the computer program product further comprising instructions which, when executed by the computer processor, cause the computer to:
gather sale parameters from one or more remote devices of vendors of the first and second set of vendors in response to receiving the first and second set of vendor indications;
compare the first user characteristics to the sale parameters; and
identify the first subset of the first set of vendors and the second subset of the second set of vendors, wherein both the first and second subsets include sale parameters that are satisfied by one or more first user characteristics.

23. The computer program product of claim 20, wherein the sale parameter is at least one of a:
geographical territory in which the vendor provides commercial offerings, wherein the first user characteristics includes a user address within the geographical territory; or
contractual specification of the vendor, wherein the first user characteristics indicate a willingness to satisfy the contractual specification.

24. The computer program product of claim 20, wherein the online post includes a third element that is an alternate element for the second element such that the second and third elements are mutually exclusive.

25. The computer program product of claim 20, the computer program product further comprising instructions which, when executed by the computer processor, cause the computer to generate both a first set of confidence scores for the matches of the first subset of the first set of vendors to the first element for the first user and a second set of confidence scores for the matches of the second subset of the second set of vendors to the second element for the first user, wherein the first and second sets of confidences scores are provided for the user and displayed by the GUI.
